(19) United States
(12) Patent Application Publication
(10) Pub. No.: US 2002/0164953 A1
(43) Pub. Date: Nov. 7, 2002

(54) Bluetooth adaptor

(76) Inventor: Jeremy Curtis, Bedforshire (GB)

Correspondence Address: BEYER WEAVER & THOMAS LLP, P.O. BOX 778, BERKELEY, CA, 94704-0778, US

(21) Appl. No.: 10/049,533

(22) PCT Filed: Jun. 13, 2001
(86) PCT No.: PCT/GB01/02585

(30) Foreign Application Priority Data
Jun. 13, 2000 (GB) 0014431.1
Dec. 4, 2000 (GB) 0029543.6

(51) Int. Cl. H04B 5/00

(52) U.S. Cl. 455/41; 455/557

(57) ABSTRACT

The present invention provides an adaptor, system and a method for allowing a communications device to accept a connection from a Bluetooth enable device. This is achieved by coupling the communications device to an adaptor which is configured to accept a Bluetooth connection from a Bluetooth enable device. The communications device periodically generates a connection request signal which is transferred to the adaptor. Once the Bluetooth connection has been established, the adaptor then establishes a connection with the communications deformed between the communications device and the Bluetooth enable device, with the communications device acting as a slave.

### FIELD OF THE INVENTION

The present invention relates to a Bluetooth adapter for allowing a communications device to accept a connection from a Bluetooth enabled device. In particular, the adaptor allows a device such as a PDA to communicate with Bluetooth devices whilst acting as a slave.

### BACKGROUND TO THE INVENTION

Currently, the majority of computer networks utilize some form of wiring for interconnecting the computers on the network. These systems suffer from the major drawbacks that wiring has to be installed within the building to enable the network to be fitted, and additionally, should a fault with the wiring develop, this can lead to the need for wiring to be replaced. In addition to this, the wiring can cause electromagnetic noise problems due to interference with other electrical equipment within the building, as well as only having a limited bandwidth. Furthermore, different networks require different wiring standards which further leads to the complexity of installing networks in buildings.

Wireless types of networks are now becoming more wide spread. Wireless communication can be broken down into one of three main categories, radio, cellular and local. Radio communications are used for mainly long distance work, and cellular communications are used for mobile phones and the like. At present, the cellular system can also be used to provide limited Internet access using WAP (Wireless Application Protocol) phones. Internet access is also possible via a cellular phone, a GSM modem and a PC/PDA.

In addition to this, the local communication standards are also provided for short-range radio communication. These systems have been used within the production of wireless networks.

One such short-range radio communication radio system is Bluetooth which can be used to provide customer premises wireless links for voice, data and multimedia applications.

A Bluetooth Radio Frequency (RF) system is a Fast Frequency Hopping Spread Spectrum (FFHSS) system in which packets are transmitted in regular time slots on frequencies defined by a pseudo random sequence. A Frequency Hopping system provides Bluetooth with resilience against interference. Interference may come from a variety of sources including microwave ovens and other communication systems operating in this unlicensed radio band which can be used freely around the world. The system uses 1 MHz frequency hopping steps to switch among 79 frequencies in the 2.4 GHz Industrial, Scientific and Medical (ISM) band at 1600 hops per second with each channel using a different hopping sequence.

The Bluetooth baseband architecture includes a Radio Frequency transceiver (RF), a Link Controller (LC) and a Link Manager (LM) implementing the Link Manager Protocol (LMP).

Bluetooth version 1.1 supports asymmetric data rates of up to 721 Kbits per second and 57.6 Kbits per second and symmetric data rates of up to 432.5 Kbits per second. Data transfers may be over synchronous connections, Bluetooth supports up to three pairs of symmetric synchronous voice channels of 64 Kbits per second each. Bluetooth connections operate in something called a piconet in which several nodes accessing the same channel via a common hopping sequence are connected in a point to multi-point network. The central node of a piconet is called a master that has up to seven active slaves connected to it in a star topology. The bandwidth available within a single piconet is limited by the master, which schedules time to communicate with its various slaves. In addition to the active slaves, devices can be connected to the master in a low power state known as park mode, these parked slaves cannot be active on the channel but remain synchronised to the master and addressable. Having some devices connected in park mode allows more than seven slaves be attached to a master concurrently. The parked slaves access the channel by becoming active slaves, this is regulated by the master.

Multiple piconets with overlapping coverage may co-operate to form a scatternet in which some devices participate in more that one piconet on a time division multiplex basis. These and any other piconets are not time or frequency synchronised, each piconet maintains is own independent master clock and hopping sequence.

The Bluetooth protocol operates by having devices generating polling signals when they need to transfer data to another nearby Bluetooth enabled device. In this example, when a Bluetooth enabled device detects a polling signal, it generates a response causing a connection to be established between the two devices. In this example, the device generating the polling signal becomes the master, with the device accepting the polling signal being the slave. The operation of the Bluetooth protocol is configured so that the master Bluetooth radio defines the hopping sequence used by the two devices.

In most circumstances, Bluetooth is used to allow one-to-one communication between two devices. Accordingly, in this circumstance, it does not matter which device is the slave and which is the master.

However, systems have been proposed which use a number of network nodes which can communicate wirelessly with end stations coupled to the network. The network nodes are interconnected to a network server, which can be used to provide additional services, such as Internet connection. The system uses at least a local short range radio connection for interconnecting the network nodes to the communications devices. This allows the user access to the network from anywhere within range of a network node. Accordingly, if network nodes are located throughout a building the user can have access to the communications network at any location within the building.

In order to function correctly, the network nodes must be capable of communicating with a number of different devices simultaneously. In the case of Bluetooth this can only be achieved if the radio (Bluetooth radio device) of the network node functions as a master radio, with the communications devices operating as slaves. Thus, it is necessary for each of the Bluetooth network nodes to be configured as a master radio at all times. This ensures that even if a number of different slave radios are associated with any one given master, the slave radios all follow the hopping sequence of the master radio.

Thus, if the network node becomes a slave, it is only able to communicate with the communications device which is currently functioning as the master, thereby preventing the network node communicating with other communications devices.

In order to overcome this problem, a role change facility is provided within the Bluetooth specification. However, this is not currently implementable in all circumstances.

### SUMMARY OF THE INVENTION

In accordance with a first aspect of the present invention, we provide a Bluetooth adaptor for allowing a communications device to accept a connection from a Bluetooth enabled device, the communications device having an output which periodically outputs a connection request signal, the adaptor comprising:

an input for coupling to the output;

a radio for providing Bluetooth connectivity; and,

a processor coupled to the input and the radio, wherein, in use the processor is adapted to:

cause a Bluetooth connection to be established in response to a connection request from the Bluetooth enabled device; and,

once the Bluetooth connection has been established, cause a connection to be established with the communications device via the input in response to a connection request signal received at the input.

In accordance with a second aspect of the present invention, we provide a system for allowing a communications device to accept a connection from a Bluetooth enabled device, the system comprising:

a communications device having:

an output; and,

a processor coupled to the output, the processor being adapted to

periodically generate a connection request signal at the output,

an adaptor having:

an input for coupling to the output;

a radio for providing Bluetooth connectivity; and,

an adaptor processor coupled to the input and the radio, wherein, in use the processor is adapted to:

cause a Bluetooth connection to be established in response to a connection request from the Bluetooth enabled device; and,

once the Bluetooth connection has been established, cause a connection to be established with the communications device via the input in response to the connection request signal received at the input.

In accordance with a third aspect of the present invention, we provide a method of causing a communications device to accept a connection from a Bluetooth enabled device, the method comprising:

coupling the communications device to an adaptor;

causing the communications device to periodically output a connection request signal;

causing the adaptor to accept a Bluetooth connection from the Bluetooth enabled device in response to a connection request; and,

once the Bluetooth connection has been established, causing the adaptor to establish a connection with the communications device in response to a connection request from the communications device.

Accordingly, the present invention provides an adaptor, a system and a method for allowing a communications device to accept a connection from a Bluetooth enabled device. This is achieved by coupling the communications device to an adaptor which is configured to accept a Bluetooth connection from a Bluetooth enabled device. The communications device periodically generates a connection request signal which is transferred to the adaptor. Once the Bluetooth connection has been established, the adaptor then establishes a connection with the communications device in response to a connection request signal. Communication can then be performed between the communications device and the Bluetooth enabled device, with communications device acting as a slave.

The communications device is usually adapted to communicate in accordance with a first communications protocol, with the Bluetooth enabled device being adapted to communicate in accordance with a second communications protocol. In this situation the processor is preferably adapted to translate data between the first and second protocols as required. However, the translation of data is not necessarily required in all circumstances. Alternatively, the translation could be performed by either the communications device, or the Bluetooth enabled device.

Typically the communications device is a PDA, in which case the input of the adaptor is adapted to couple to the output of a PDA. As will be appreciated by a person skilled in the art the present invention could of course be implemented with many devices, such as lap tops, palm tops and the like. However, the adaptor is designed primarily for working with a computing device which is unable to perform Bluetooth communication itself, but which is able to communicate via a modem. Accordingly, in this case, the first communications protocol is a standard modem protocol operated by the PDA to allow it to communicate with external devices via a modem. Similarly, the second communications protocol is the Bluetooth protocol.

Accordingly, the adaptor usually communicates with the PDA using the modem protocol and then translates the data for transmission over the Bluetooth connection.

The adaptor typically further comprises a store for storing data to be transferred between the Bluetooth enabled device and the communications device. This provides a buffer allowing data to be temporarily stored before it is transferred on. This may be required for example if the Bluetooth connection is at maximum capacity and additional data is still being received from the communications device. Alternatively, the buffer may be used when data is being translated between the first and second protocols.

### BRIEF DESCRIPTION OF THE DRAWINGS

An example of the present invention will now be described in detail with reference to the accompanying drawings, in which:

FIG. 1 is a schematic diagram of a communications system according to the present invention;

FIG. 2 is a schematic diagram of a Bluetooth network;

FIG. 3 is a schematic diagram of the Access Server of FIG. 2; and,

FIG. 4 is a schematic diagram of the Access Point of FIG. 2.

### DETAILED DESCRIPTION

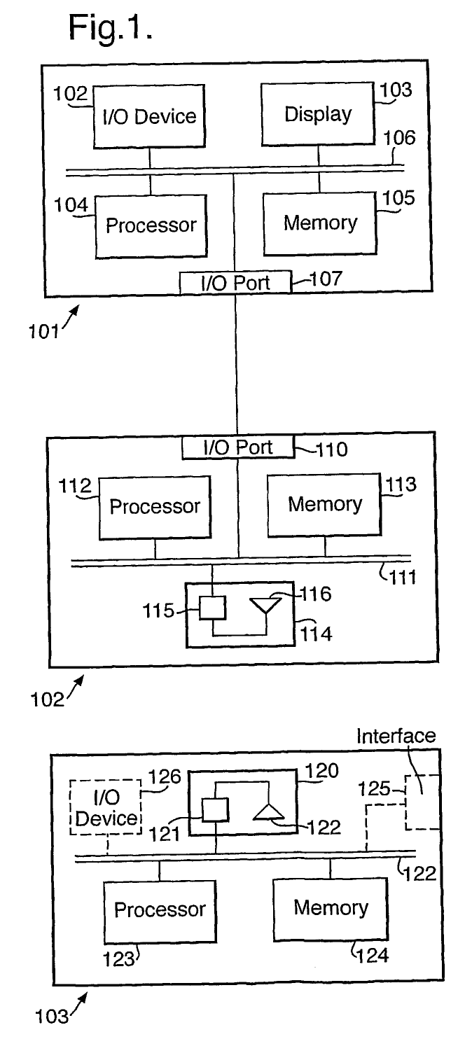

FIG. 1 shows a communication system according to the present invention. As shown, the communications system is formed from a communications device 101 coupled to an adaptor 102 which are arranged to communicate with the Bluetooth enabled device 103. The communications device 101 typically comprises a PDA, a lap top, a computer or the like which is not adapted for Bluetooth communication. Accordingly, the communications device 101 typically includes an input/output device 102, a display 103, a processor 104, and a memory 105 coupled together via a bus 106. The bus 106 is also coupled to an input/output (I/O) port 107.

The adaptor 102 is designed to communicate with the communications device via the I/O port 107 and provide onward Bluetooth connectivity to the Bluetooth enabled device 103. The adaptor includes a first I/O port 110 which is coupled to a bus 111. The bus 111 is in turn coupled to a microprocessor 112, a memory 113 and a Bluetooth radio 114. The Bluetooth radio 114 includes a Bluetooth stack 115 and an antenna 116.

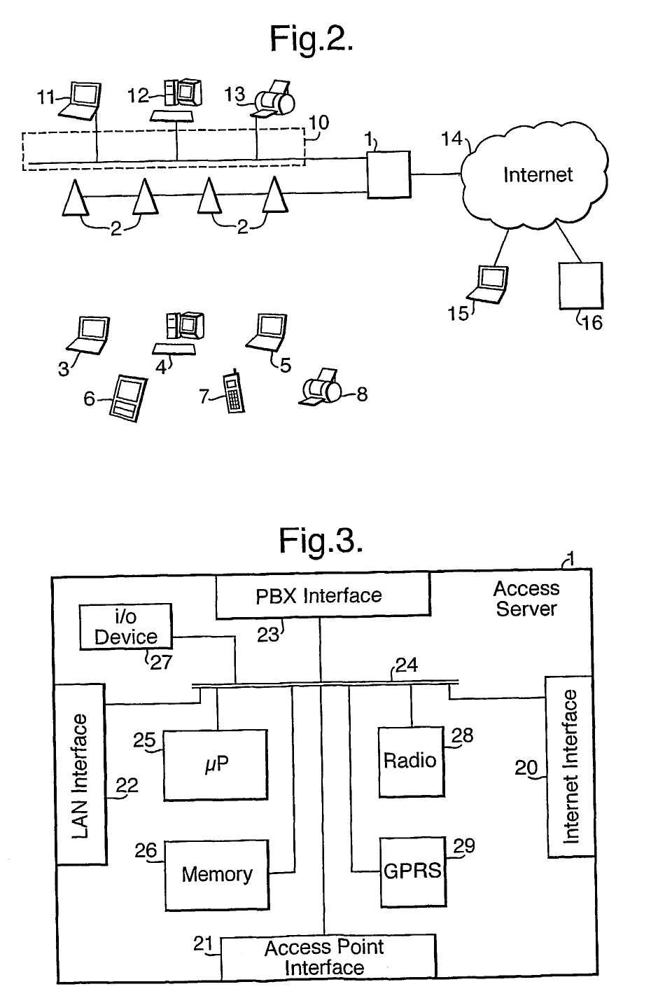

The Bluetooth enabled device 103 may be any device capable of Bluetooth communication, such as a Bluetooth enabled PC, a Bluetooth enabled palm top, Bluetooth enabled PDA or the like. Furthermore it may be a node in a Bluetooth network, such as an Access Point which will be described in more detail below with respect to FIGS. 2 to 4.

In any event, the Bluetooth enabled device 103 will typically include a Bluetooth radio 120 formed from a Bluetooth stack 121 and an antenna 122. The Bluetooth radio 120 is coupled to a bus 121 which is in turn coupled to a microprocessor 123 and a memory 124. Depending on the nature of the Bluetooth device 103 there may also be provided, as shown by the dotted lines, an interface 125 for coupling the device to a network or the like, or an input/output device 126, which may include a display.

Operation of the system will now be described.

When a Bluetooth connection is to be established between two Bluetooth devices, one of the devices must generate a poling signal which is then received by the other device. The other device then generates a response causing the Bluetooth connection to be established. When this happens, the device which accepts the poling signal and generates a response must synchronize its own hopping sequence with that of the device initiating the contact. In these circumstances the device generating the poling signal is the master with the connected device being the slave.

However, it is often desirable to maintain specific master and slave relationships between two devices. Thus, for example the communications device 101 is not adapted for use as a Bluetooth device under normal circumstances. Accordingly, for this reason alone, it is typically preferable for the communications device 101 and the adaptor 102 to accept a Bluetooth connection and thereby maintain a slave status rather than attempting to make a Bluetooth connection and assert a master status over a Bluetooth device which is specifically adapted for Bluetooth communication.

In addition to this, it is often desired to use the communications device 101 and the adaptor 102 for communication with a Bluetooth network. In this case, as will be described below with respect to FIGS. 2 to 4, it is necessary for the adaptor 102 to act as a slave. Accordingly, the adaptor 102 must be able to accept a Bluetooth connection from the Bluetooth enabled communications device 103.

In order to achieve this, the microprocessor 112 of the adaptor 102 is adapted to control the radio 114 so that it does not periodically generate poling signals in the normal way. Instead, the generation of poling signals is inhibited so that the adaptor 102 is unable to request the establishment of a Bluetooth connection. As a result, the adaptor 102 can only passively accept Bluetooth connections.

In use, when the adaptor 102 is brought in range of a Bluetooth device 103, the Bluetooth device 103 periodically generates a poling signal in the normal way. The poling signal is generated by the radio 120 and is received by the radio 114 of the adaptor 102. The poling signal is transferred to the Bluetooth stack 115 which in turn transfers an indication that a Bluetooth connection is requested to the microprocessor 112 via the bus 111.

The microprocessor 112 can then act in one of two ways. Either the microprocessor 112 can simply operate to accept the connection, or the microprocessor 112 can first determine whether a connection is required by the user. In the latter case, the microprocessor 112 determines whether a Bluetooth connection is required by using a poling system between the communications device 101 and the adaptor 102. In this case, when the user of the communications device 101 needs a Bluetooth connection, the user enters an indication of this via the I/O device 102. This may be by selecting an icon presented to the user on the display 103, by activating a certain key on a keypad, or the like.

This causes the processor 104 to periodically (approximately every 10 ms) generate a poling signal indicating that a Bluetooth connection is required. This poling signal is transferred via the bus 106, the I/O port 107, and the I/O port 110 to the microprocessor 112. The microprocessor 112 then determines that a Bluetooth connection is required and will await a Bluetooth poling signal to be received by the radio 114. When the Bluetooth poling signal has been received by the radio 114 the microprocessor 112 determines that the communications device 101 requires a Bluetooth connection and accordingly, causes the radio 114 to generate a response. The response is received by the radio 120 of the Bluetooth enabled device 103 causing a connection to be established.

In this case the hopping sequence of the radio 114, which is controlled by the Bluetooth stack 115 will be adapted to mimic the hopping sequence of the Bluetooth enabled device 103 such that the Bluetooth enabled device 103 remains as the master unit.

Once a Bluetooth connection has been established, the microprocessor 112 transfers a connection confirmation via the I/O port 10 to the communications device 101. The microprocessor 104 for the communications device 101 will then generate an indication on the display 103 indicating to the user that the Bluetooth connection has been established. Data can then be transferred as required.

Thus for example, the user may wish to transfer data from the communications device 101, to the Bluetooth enabled device 103. This data is first placed in a format suitable for transfer via the I/O port 107 and transferred to the adaptor 102. As the majority of communications devices 101 are capable of communicating via a modem connection, the format of the data is typically suitable for transmission via a modem. Accordingly, when the data is received by the adaptor 102 it is temporarily stored in the memory 113. The microprocessor 112 then operates to translate the data into a format suitable for transmission via the radio 114. The data is transferred to the Bluetooth stack 115 which is placed in a Bluetooth format and then transmitted by the antenna 116 to the radio 120. The data is then transferred via the Bluetooth stack 121 to the microprocessor 123 for use as appropriate.

Similarly, the adaptor 102 is designed to translate data received at the radio 114 into a format suitable for transmission via the I/O port 107 to the communications device 1.

As a minor variation to the above procedure, the adaptor 102 can be adapted to accept a Bluetooth connection if it is available. A connection between the adaptor 102 and the communications device 101 is only established however upon the generation of a poling signal by the processor 104 of the communications device 101. Accordingly, the overall connection between the communications device 101 and the Bluetooth device 103 is only established when the user of the communications device indicates a connection is needed.

Alternatively however, the processor 104 can be adapted to periodically generate a poling signal automatically at all times the device is active.

As a result, whenever a Bluetooth poling signal is detected by the adaptor 102, a response is generated so that the Bluetooth connection is established. This allows the Bluetooth device 103 to transfer data to the communications device 101 automatically. This will allow synchronization of diaries and the like to be carried out automatically as soon as the communications device 101 and the adaptor 102 enter the range of the Bluetooth enabled device 103.

The above explains the general techniques of the present invention. An example of circumstances in which the general techniques are used will now be described with reference to FIGS. 2 to 4.

FIG. 2 shows a basic network arrangement which includes an Access Server 1 which is coupled to a number of local area network Access Points 2. The Access Points 2 are designed to communicate with a number of wireless communications devices 3,4,5,6,7,8 using a wireless communications protocol, which in this example is the Bluetooth protocol.

The wireless communication devices 3,4,5,6,7,8 can include devices such as a personal computer, laptop or the like which is fitted with a Bluetooth adapter, a specialised Bluetooth laptop, a Bluetooth enabled phone or mobile phone, a WAP Internet phone, a Bluetooth enabled printer, a Bluetooth enabled personal data assistant (PDA) or a Bluetooth headset. In this example, each of these devices will be able to communicate with the Access Points thereby allowing the devices to obtain data from, or send data to the Access Server.

In fact, the Access Server & Access Point can communicate with any Bluetooth enabled device. These include not only PCs, PDAs, and laptops but any of the following that have a Bluetooth port; a truck, a refrigerator, a baggage trolley, a keyboard etc.

The Access Server 1 is also optionally connected to a local area network 10 having a number of end stations 11,12,13. In this example, this allows the Access Server to be integrated with currently existing local area networks within a building.

The Access Server 1 can also be connected to a remote communications network 14, which in this example is the Internet. This allows the communications devices coupled to the Access Server to communicate with remote users 15 or Access Servers of other remote sites 16.

Accordingly, the Access Points 2 allow the wireless communications devices 3,4,5,6,7,8 to communicate with the LAN 10 and the Internet 14 via the Access Server 1. The Access Server will typically operate as a network server and can therefore typically store information to be retrieved by the communications devices, including information downloaded from the Internet The Access Server is shown in more detail in FIG. 3.

The Access Server may include an Internet interface 20, an Access Point interface 21, a LAN interface 22 and a PBX interface 23, all of which are interconnected via a bus 24. A microprocessor 25 and a memory 26 which are provided for processing and storing the operating software, are also coupled to the bus 24. An input/output device 27 is also provided.

The processor 25 is typically an x86 type processor operating a Linux type operating system such as Red Hat Linux. This is particularly advantageous as the Linux system is widely used as the operating system for a number of different software applications. Accordingly, the system can implement a wide variety of standard operating software for network servers and the like, as well as allowing third parties the opportunity to modify existing software and develop their own software. However, any suitable form of processing system may be used.

In addition to these features, it is also possible to include a number of Bluetooth radios 28, and a GPRS transceiver 29, both of which are coupled to the BUS 24.

A range of radios are supported, including standard and enhanced range devices.

Similarly, the Bluetooth design of the Access Server and the Access Point offers capabilities beyond the basic Bluetooth specification. These include advanced control of Bluetooth device state to improve throughput, and control of broadcast and multicast traffic streams to/from Bluetooth devices.

In this example, four different interfaces 20,21,22,23 are shown. However, it is not essential for the Access Server 1 to include all of these interfaces, depending on the particular configuration which is to be used, as will be explained in more detail below.

Thus, in order to enable Bluetooth communication between the wireless communication devices and the Access Server, only the Access Point interface 21, with appropriately connected Access Points 2, is required. In this case the Internet interface 20, the LAN interface 22 and the PBX interface 23 are not necessarily required. Alternatively, the Access Point interface need not be used if the Bluetooth radios are used instead. However, this will become clearer when various network configurations used by the Access Server are described in more detail below.

The Internet interface 20 is used primarily for providing an ISDN connection to an Internet service provider. However, the system can be reconfigured to use Ethernet, DSL or a POTS modem for Internet connectivity.

The Access Point interface 21 is effectively an Ethernet interface which is adapted to operate with the Access Points, as will be explained in more detail below.

The LAN interface 22 is normally configured to be an Ethernet interface. However, this can be adapted to provide token ring or other forms of communication as required. Accordingly the LAN 10 can comprise an Ethernet, Token Ring or other similar network.

In order to be able to handle different communications protocols, each of the interfaces 20,21,22 will include a processor and a memory. The processor operates software stored in the memory which is appropriate for handling the required communications protocol. Thus in the case of the LAN interface 21, the default protocol is Ethernet. However, if alternative protocols such as Token Ring or ATM are used, then the software is adapted to translate the format of the data as it is transferred through the respective interface.

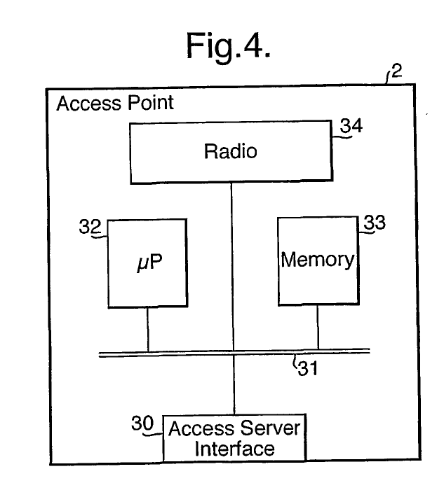

An Access Point according to the present invention is shown in FIG. 4. The Access Point includes an Access Server interface 30, for connecting the Access Point to the Access Server. The Access Server interface 30 is connected via a BUS 31 to a processor 32 and a memory 33. The BUS is also coupled to a number of Bluetooth radios 34 (only one shown) providing enhanced capabilities such as improved bandwidth and call density.

The processor 32 is typically a processor system that can include one or more processors, of the same or different types within the system. For example, the processor system could include, but is not be limited to, a RISC (Reduced Instruction Set Computer) processor and a DSP (Digital Signal Processor) processor.

In use, the Access Points are connected to the Access Point interface 21 using a daisy chain Ethernet connection. This is particularly advantageous as it allows a large number of Access Points 2 to be connected in series via a single wire to the Access Point interface 21. In this case, power can be supplied to the Access Points 2 either via the connection from the Access Server 1, or via separate power supplies (not shown) connected to each of the Access Points 2 as required.

As an alternative however, the Access Points 2 may be connected to the Access Server 1 via an Ethernet hub, which generally allows a larger number of Access Points to be connected to each Access Server.

In use, each Access Point 2 is able to communicate with a number of communications devices 3,4,5,6,7,8 which are in range of the respective radio 34.

Any data received at the radio is transferred to the memory 33 for temporary storage. The processor 32 will determine from the data the intended destination. If this is another Bluetooth device within range of the Access Point, the data will be transferred via the radio 34 to the appropriate communications device 3,4,5,6,7,8. Otherwise the data will be transferred via the BUS 31 to the Access Server interface 30 and on to the Access Server 1.

Upon receipt of the data by the Access Server 1, the Access Point interface 21 will temporarily store the data in the memory whilst the processor determines the intended destination of the data. The processor may also operate to translate the format of the data, if this is necessary. The data is then routed by the Access Server to the intended destination on either the LAN 2, the Internet 14 or alternatively, to a PBX network, as will be described in more detail below.

The traffic from Bluetooth devices (arriving through a Access Point or the Access Server) can be sent to the LAN through a number of different mechanisms; one is routing, another uses a technique called Proxy ARP to reduce the configuration needed. These mechanisms are bi-directional and also connect traffic from the LAN to Bluetooth devices.

Similarly, data can be transferred from the Access Server, via the Access Point interface 21 to a Access Point 2. In this case, the Access Point 2 receives the data and transfers it into the memory 33. The processor 32 then uses the data to determine the intended destination communication device before routing the data appropriately.

Accordingly, as will be appreciated from the above, each Access Point 2 is designed to be coupled to one or more communications devices 3,4,5,6,7,8, allowing the configuration shown in FIG. 2 to function as a network, with wireless connections to the communications devices 3,4,5,6,7,8. Accordingly, in this example, the Access Points 2 function as network nodes, with the Access Server 1 forming the network server to control the operation of the network.

As described above, when a communications device is initially brought into range of one of the Access Points 2 it is necessary for a connection to be established between the two devices. In order to do this, the Bluetooth communication protocol causes one of the devices to generate a polling signal. In general, the polling signal will be generated by the device which wants to initiate a connection.

Thus, if one of the Access Points 2 is attempting to connect to a communications device, the Access Point 2 will generate a polling signal which is then broadcast to the communications device. Upon receipt of the polling signal, the communications device will generate a response which operates to synchronize the packet hopping sequences of the communications device and the Access Point 2. When this has been completed, a connection is in place between the two devices allowing communication to be achieved. In this case, the Access Point 2 acts as the master and is therefore in control of the hopping sequence.

However, problems arise when the communications device attempts to transfer data to the Access Point 2. In this case, if the communications device generated a polling signal, this would be detected by the Access Point 2, causing the Access Point 2 to generate a response. The generation of this response would cause a connection to be initiated in which the Access Point 2 is acting as a slave. In this circumstance, the hopping sequence of the Access Point 2 is synchronized with that of the communications device. This would override any currently existing hopping sequence.

Thus, if the Access Point 2 were currently in communication with other communications devices, as the Access Points hopping sequence would be changed, this would cause the currently existing connections to be broken.

In order to overcome this, the adaptor of the present invention ensures that the communications device 103 only accepts Bluetooth connections, thereby ensuring it remains as the slave.

1. A Bluetooth adaptor for allowing a communications device to accept a connection from a Bluetooth enabled device, the communications device having an output which periodically outputs a connection request signal, the adaptor comprising:
an input for coupling to the output;
a radio for providing Bluetooth connectivity; and,
a processor coupled to the input and the radio, wherein, in use the processor is adapted to:
cause a Bluetooth connection to be established in response to a connection request from the Bluetooth enabled device; and,
once the Bluetooth connection has been established, cause a connection to be established with the communications device via the input in response to a connection request signal received at the input.

2. An adaptor according to claim 1, wherein the communications device is adapted to communicate in accordance with a first communications protocol, and wherein the Bluetooth enabled device is adapted to communicate in accordance with a second communications protocol, the processor being further adapted to translate data between the first and second protocols as required.

3. An adaptor according to claim 1 or claim 2, wherein the input is adapted to couple to the output of a PDA.

4. An adaptor according to any of the preceding claims, wherein the adaptor further comprises a store for storing data to be transferred between the Bluetooth enabled device and the communications device.

5. A system for allowing a communications device to accept a connection from a Bluetooth enabled device, the system comprising:
a communications device having:
an output; and,
a processor coupled to the output, the processor being adapted to periodically generate a connection request signal at the output,
adaptor having:
an input for coupling to the output;
a radio for providing Bluetooth connectivity; and,
an adaptor processor coupled to the input and the radio, wherein, in use the processor is adapted to:
cause a Bluetooth connection to be established in response to a connection request from the Bluetooth enabled device; and,
once the Bluetooth connection has been established, cause a connection to be established with the communications device via the input in response to the connection request signal received at the input.

6. A system according to claim 5, wherein the communications device is a PDA.

7. A system according to claim 5 or claim 6, wherein the output is for coupling to a modem, the connection request signal being a modem connection request signal.

8. A system according to any of claims 5 to 7, wherein the processor is adapted to periodically generate the connection request signal in response to a request from the user of the communications device.

9. A system according to any of claims 5 to 8, wherein the communications device is adapted to communicate in accordance with a first communications protocol, and wherein the Bluetooth enabled device is adapted to communicate in accordance with a second communications protocol, the adaptor processor being further adapted to translate data between the first and second protocols as required.

10. A system according to any of claims 5 to 9, wherein the adaptor is an adaptor according to any of claims 1 to 4.

11. A method of causing a communications device to accept a connection from a Bluetooth enabled device, the method comprising:
coupling the communications device to an adaptor;
causing the communications device to periodically output a connection request signal;
causing the adaptor to accept a Bluetooth connection from the Bluetooth enabled device in response to a connection request; and,
once the Bluetooth connection has been established, causing the adaptor to establish a connection with the communications device in response to a connection request from the communications device.

12. A method according to claim 11, wherein the method further comprises causing the communications device to periodically output a connection request signal in response to a request from the user of the communications device.

13. A method according to claim 11 or claim 12, wherein the adaptor accepts a Bluetooth connection from the Bluetooth enabled device by:
monitoring for a connection request signal from the Bluetooth enabled device; and,
generating a response indicating that the connection is to be accepted.

14. A method according to any of claims 11 to 13, wherein the communications device is adapted to communicate in accordance with a first communications protocol, and wherein the Bluetooth enabled device is adapted to communicate in accordance with a second communications protocol, the method further comprising causing the adaptor to translate data between the first and second protocols as required.
